(19) United States
(12) Patent Application Publication
(10) Pub. No.: US 2011/0094849 A1
(43) Pub. Date: Apr. 28, 2011

(54) PARKING LOCK FOR A VEHICLE TRANSMISSION AND VEHICLE WITH A PARKING LOCK

(75) Inventor: Sascha Schlieker, Frankfurt (DE)

(73) Assignee: GM GLOBAL TECHNOLOGY OPERATIONS, INC., Detroit, MI (US)

(21) Appl. No.: 12/909,657

(22) Filed: Oct. 21, 2010

(30) Foreign Application Priority Data
Oct. 22, 2009 (DE) 102009050336.6

(51) Int. Cl. F16H 61/22

(52) U.S. Cl. 192/219.5

(57) ABSTRACT

A parking lock is provided for a vehicle transmission. A parking lock gear rim can be connected with a transmission housing in a rotationally fixed manner through at least one locking pawl, and the parking lock gear rim is designed as crown wheel gear rim and arranged on a ring gear of a differential of the vehicle transmission perpendicularly to the plane of the ring gear.

### CROSS-REFERENCE TO RELATED APPLICATION

This application claims priority to German Patent Application No. 102009050336.6, filed Oct. 22, 2009, which is incorporated herein by reference in its entirety.

### TECHNICAL FIELD

The invention relates to a parking lock for a vehicle transmission, more preferably for an automatic vehicle transmission or an automated shift transmission, as well as a vehicle with such a parking lock.

### BACKGROUND

In order to prevent vehicles with automatic transmission from rolling away with the engine switched off, parking lock devices are provided which interlock the transmission output with the transmission housing by means of a locking pawl engaging in a parking lock gear. Such a parking lock device is known for example from DE 10 2008 000 263 A1. From DE 101 31 735 A1 it is known to arrange the parking lock gear on a differential gear cage next to the ring gear of the differential cage in a rotationally fixed manner.

At least one object of the invention is to state a parking lock for an automatic vehicle transmission that is particularly light and can be favorably integrated in the transmission housing. In addition, other objects, desirable features, and characteristics will become apparent from the subsequent summary and detailed description, and the appended claims, taken in conjunction with the accompanying drawings and this background.

### SUMMARY

A parking lock is provided for a vehicle transmission, wherein a parking lock gear rim can be connected with a transmission housing in a rotationally fixed manner through at least one locking pawl, comprises a parking lock gear rim designed as crown wheel gear ring. The parking lock gear rim is arranged on a ring gear of a differential perpendicularly to the plane of the ring gear in the manner of a crown wheel gear rim.

Accordingly, with the parking lock according to the invention, the parking lock gear is integrated in the ring gear of the differential in that the parking lock toothing is accommodated on the ring gear. Since the ring gear is designed as spur gear with teeth arranged on its circumference, the parking lock toothing is designed as crown wheel toothing so that on the front or back of the ring gear left clear it can be arranged perpendicularly to its plane.

The parking lock has the advantage that through the integration of the parking lock gear in the ring gear of the differential cage it utilizes particularly little space and is also very light. In addition it makes possible shortening of the output shaft through the saved gear and thus a smaller transmission construction.

In an embodiment the parking lock gear rim is arranged on the side of the ring gear facing away from the differential cage in order to have available more space for the arrangement of the locking pawl and its actuation device.

In an embodiment the toothing of the parking lock gear rim comprises teeth and tooth gaps, wherein the tooth gaps are substantially formed as cuboid clearances in the ring gear. In this embodiment, the teeth of the parking lock gear rim therefore do not protrude over the plane of the ring gear, but are formed through the ring gear surface between the tooth gaps in the manner of webs.

In an alternative embodiment the teeth of the parking lock gear rim are substantially formed as cuboid ribs on the ring gear.

The locking pawl is advantageously assigned an actuation device with an actuated position, in which a locking region of the locking pawl is brought into engagement with the parking lock gear rim, i.e., engages in a tooth gap or is pressed against a tooth, so that the ring gear is locked. In a non-actuated position it is not brought into engagement with the parking lock gear and the ring gear is not locked.

In an embodiment the actuation device comprises a first region and a second region. In the actuated position of the actuation device the second region is in contact with the locking pawl and exerts a force on said locking pawl, which presses a locking region of the locking pawl against the parking lock gear rim. Here, the body of the actuation device can be designed in such a manner that it has a smaller diameter in the first range than in the second range, wherein between the first range and the second range a truncated cone-shaped transition region is arranged, whose diameter grows ramp-like from the first region to the second region. In this manner, the actuation device can slide over the top of the locking pawl.

In an embodiment the actuation device can be disengaged against a spring force from a non-actuated into the actuated position. Accordingly, the locking pawl in the non-actuated position is prevented from engaging in the parking lock gear rim by a retaining spring.

In an alternative embodiment the actuation device can be swiveled from a non-actuated into the actuated position. Here, at least one actuation device of the locking pawl can be arranged in stiffening braces of the transmission housing. With this embodiment, which can be realized with suitable housing types, wherein stiffening braces are provided in a region that is suitable for the arrangement of the actuation device, additional space saving is obtained.

### BRIEF DESCRIPTION OF THE DRAWINGS

The present invention will hereinafter be described in conjunction with the following drawing figures, wherein like numerals denote like elements, and.

FIG. 1 schematically shows a parking lock for a vehicle transmission according to an embodiment of the invention and

FIG. 2 schematically shows a further view of the parking lock according to FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

The vehicle transmission 1 in the embodiment shown is designed as automated shift transmission, specifically as double-clutch transmission of which in the figure merely the transmission part 2 comprising the gears facing the clutch and the transmission unit 3 comprising the gears facing the transmission output are shown.

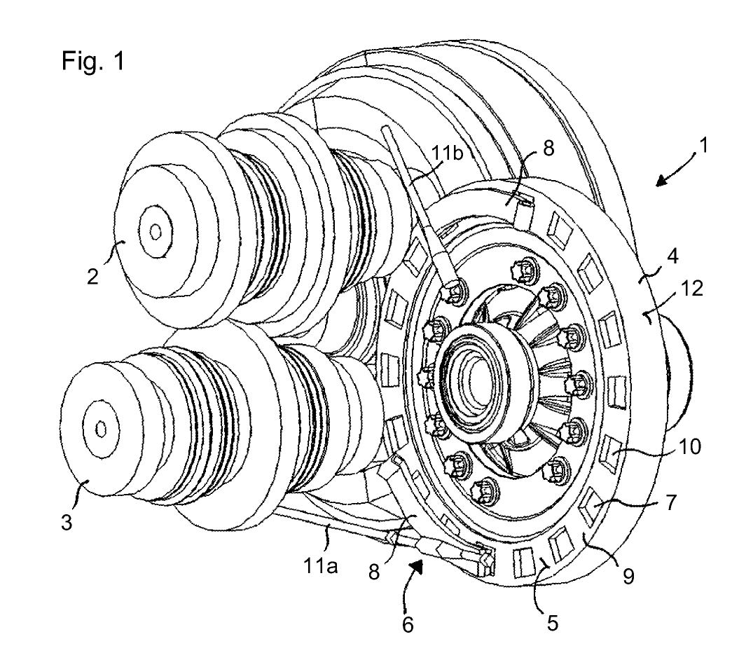

FIG. 1 shows the ring gear 4 of the differential in which gears of the transmission part 3 not shown in detail engage. The ring gear 4 comprises a front 5 and a back which is not shown in the figure, wherein the differential cage is arranged on the back.

In the region of the differential a parking lock 6 is arranged, which comprises a parking lock gear rim 7, at least one locking pawl 8 and an actuation device 11a, 11b for the locking pawl 8. Here, the parking lock gear rim 7 is arranged on the ring gear 4 of the differential so that the parking lock gear is integrated in the ring gear 4 of the differential.

The parking lock gear rim 7 comprises tooth gaps 10 designed as cuboid clearances and teeth 9 arranged as webs between the tooth gaps 10. Here, the parking lock gear rim 7 is designed as crown wheel rim wherein the teeth are arranged perpendicularly to the gear plane. The ring gear 4 thus comprises toothing both on its cylindrical side 12 as well as on its front 5, wherein the toothing on its cylindrical side 12 is not shown in the FIG. 1.

The locking pawl 8 in its actuated position engages in the parking lock gear rim 7 and interlocks the transmission output with the housing. To this end, it comprises an actuation device 11a, 11b which can disengage along an axis and engage the locking pawl 8 in the parking lock gear rim 7.

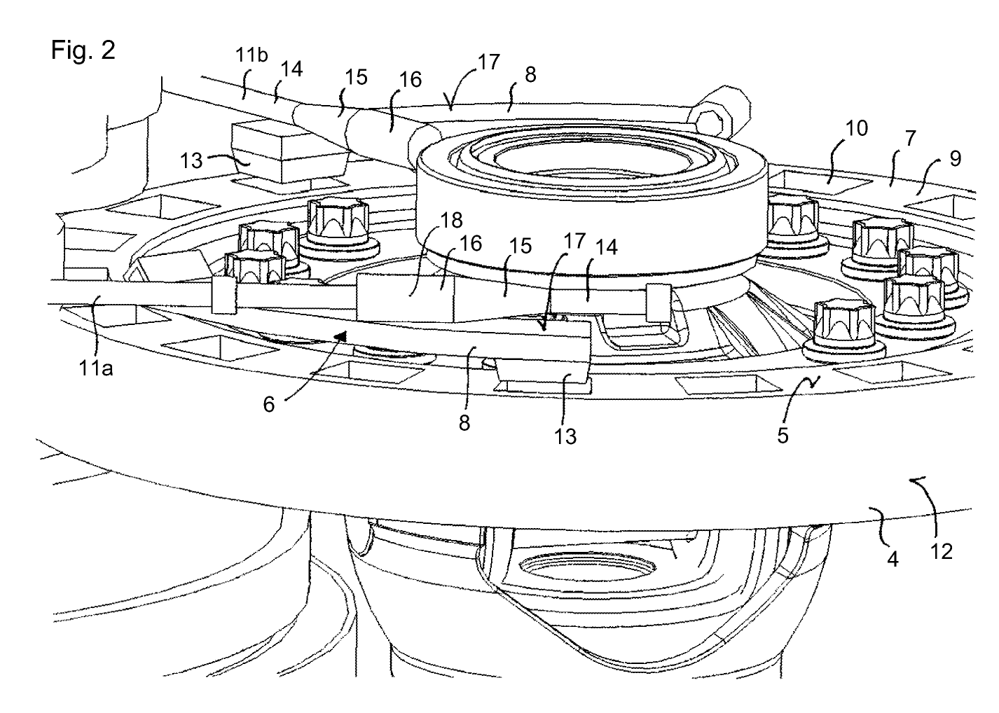

Details of the actuation device 11a, 11b are evident in FIG. 2. The two actuation devices 11a and 11b shown in the figures constitute alternative embodiments and simultaneously also two possibilities of how an actuation device 11a, 11b can be arranged. In principle, the actuation device 11a, 11b together with the locking pawl 8 can be arranged in any position on the circumference of the ring gear 4. However, it is advantageous with some transmission housings to arrange the actuation device 11a, 11b in the region of stiffening braces of the housing in order to achieve better utilization of the available space. Typically, a parking lock 6 merely has one actuation device 11a or 11b and only one locking pawl 8.

The actuation device 11a comprises a tip 18 with a first region 14, a transition region 15 and a second region 16 that can for example be disengaged against a spring force. Here, the first region 14 has a smaller diameter than the second region 16 and the transition region 15 is designed truncated cone-shaped and forms a continuous transition between the smaller diameter of the first region 14 and the larger diameter of the second region 16.

In its non-actuated position the first region 14 of the actuation device 11a is in contact with the top 17 of the locking pawl 8. Because of the small diameter of the first region 14 no adequate force is exerted on the locking pawl 8 in order to achieve engagement in the parking lock gear rim 7. If however the actuation device 11a is brought into its actuated position its tip 18 disengages, the transition region 15 sweeps over the locking pawl 8 and finally the second region comes in contact with the top 17. Because of its larger diameter the second region 16 exerts a force on the locking pawl 8, pressing the latter on to the front 5 of the ring gear 4.

If the locking region 13 of the locking pawl 8 in its size adapted to that of the tooth gaps 10 just happens to be located above a tooth gap 10 it is brought into engagement with the latter and the ring gear 4 is locked. If the locking region 13 of the locking pawl 8 just happens to be located above a tooth 9, the actuation device 11a, 11b exerts a force on the locking pawl which presses the locking region 13 against the tooth 9. With a small movement of the vehicle and thus a small rotation of the ring gear 4 it engages in the next tooth gap 10 and locks the ring gear 4.

The actuation device 11b has a similar mode of operation as the actuation device 11a. It is however constructed so that its second region 16 is located further on the end of the actuation device 11b. In its non-actuated position the first region 14 in turn is located above the locking pawl 8 and in this case is in slight contact with the top 17 of said locking pawl. In order to bring it into the actuated position, the actuation device 11b is swiveled in the plane of the ring gear 4. Alternatively, it can also be configured disengageable similar to the actuation device 11a. On swiveling into the actuated position the transition region 15 initially sweeps over the top 17 and exerts an increasingly greater force on said top until finally the second region 16 comes in contact with the top 17 and presses the locking region 13 against the ring gear 4.

Both the actuation device 11a as well as the actuation device 11b can be employed in the parking lock according to the invention depending on space available.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A parking lock for a vehicle transmission having a differential and a transmission housing, comprising:
a locking pawl; and
a parking lock gear rim through the locking pawl is adapted for connection with the transmission housing in a rotationally fixed manner,
wherein the parking lock gear rim is a crown wheel gear rim and arranged on a ring gear of the differential substantially perpendicularly to a plane of the ring gear.

2. The parking lock according to claim 1, wherein the parking lock gear rim is arranged on a front of the ring gear facing away from a differential cage.

3. The parking lock according to claim 1, wherein a toothing of the parking lock gear rim comprises teeth and tooth gaps, wherein the tooth gaps are substantially cuboid clearances in the ring gear.

4. The parking lock according to claim 1, wherein a toothing of the parking lock gear rim comprises teeth and tooth gaps, wherein the teeth are substantially cuboid ribs on the ring gear.

5. The parking lock according to claim 1, wherein the locking pawl is assigned an actuation device having a first region and a second region, wherein in an actuated position of the actuation device, the second region is in contact with the locking pawl and exerts a force that presses a locking region of the locking pawl against the parking lock gear rim.

6. The parking lock according to claim 5, wherein a body of the actuation device in the first region has a smaller diameter than in the second region and between the first region and the second region a truncated cone-shaped transition region is arranged having a diameter that grows ramp-like from that of the first region to that of the second region.

7. The parking lock according to claim 5, wherein the actuation device is adapted to disengage against a spring force from a non-actuated into the actuated position.

8. The parking lock according to claim 5, wherein the actuation device is adapted to swiveled from a non-actuated into the actuated position.

9. The parking lock according to claim 5, wherein the actuation device of the locking pawl is arranged in stiffening braces of the transmission housing.

10. A motor vehicle, comprising:
an automatic transmission having a differential and a transmission housing; and
a parking lock for the automatic transmission, the parking lock comprising:
a locking pawl; and
a parking lock gear rim through the locking pawl is adapted for connection with the transmission housing in a rotationally fixed manner,
wherein the parking lock gear rim is a crown wheel gear rim and arranged on a ring gear of the differential substantially perpendicularly to a plane of the ring gear.

11. The motor vehicle according to claim 10, wherein the parking lock gear rim is arranged on a front of the ring gear facing away from a differential cage.

12. The motor vehicle according to claim 10, wherein a toothing of the parking lock gear rim comprises teeth and tooth gaps, wherein the tooth gaps are substantially cuboid clearances in the ring gear.

13. The motor vehicle according to claim 10, wherein a toothing of the parking lock gear rim comprises teeth and tooth gaps, wherein the teeth are substantially cuboid ribs on the ring gear.

14. The motor vehicle according to claim 10, wherein the locking pawl is assigned an actuation device having a first region and a second region, wherein in an actuated position of the actuation device, the second region is in contact with the locking pawl and exerts a force that presses a locking region of the locking pawl against the parking lock gear rim.

15. The motor vehicle according to claim 14, wherein a body of the actuation device in the first region has a smaller diameter than in the second region and between the first region and the second region a truncated cone-shaped transition region is arranged having a diameter that grows ramp-like from that of the first region to that of the second region.

16. The motor vehicle according to claim 14, wherein the actuation device is adapted to disengage against a spring force from a non-actuated into the actuated position.

17. The motor vehicle according to claim 14, wherein the actuation device is adapted to swivel from a non-actuated into the actuated position.

18. The motor vehicle according to claim 14, wherein the actuation device of the locking pawl is arranged in stiffening braces of the transmission housing.
